(19) United States
(12) Patent Application Publication
(10) Pub. No.: US 2020/0387173 A1
(43) Pub. Date: Dec. 10, 2020

(54) FLIGHT CONTROL METHOD AND DEVICE FOR MULTI-ROTOR UNMANNED AERIAL VEHICLE, AND MULTI-ROTOR UNMANNED AERIAL VEHICLE

(71) Applicant: SZ DJI TECHNOLOGY CO., LTD., Shenzhen (CN)

(72) Inventors: Jiadi WANG, Shenzhen (CN); Yongsheng ZHANG, Shenzhen (CN); Guibin LIANG, Shenzhen (CN)

(21) Appl. No.: 16/860,634

(22) Filed: Apr. 28, 2020

Related U.S. Application Data
(63) Continuation of application No. PCT/CN2017/108737, filed on Oct. 31, 2017.

(51) Int. Cl. G05D 1/08; B64C 39/02; B64C 27/82

(52) U.S. Cl. CPC G05D 1/085; G05D 1/0841; B64C 39/024; B64C 2027/8227; B64C 2201/14; B64C 2201/12; B64C 2201/108; B64C 27/82

(57) ABSTRACT

Flight control method, flight control device, and multi-rotor unmanned aerial vehicle are provided. The vehicle includes a center frame, a carrier, arms, and a propulsion assembly on each arm. Each propulsion assembly includes a forward-rotating rotor, a counter-rotating rotor, a first driving device, and a second driving device. The method includes: determining a current attitude of the vehicle including a normal flight attitude with the carrier at a lower side of the center frame and an inverted flight attitude with the carrier at an upper side of the center frame; and adjusting vertical arrangement positions of the forward-rotating rotor and the counter-rotating rotor in the direction of the yaw axis according to the current attitude of the vehicle, such that the vertical arrangement positions of the forward-rotating rotor and the counter-rotating rotor remain unchanged, and each rotor maintains a state of pushing down airflow when the rotor rotates.

### CROSS-REFERENCE TO RELATED APPLICATION

This application is a continuation of International Application No. PCT/CN2017/108737, filed on Oct. 31, 2017, the entire content of which is incorporated herein by reference.

### TECHNICAL FIELD

The present disclosure relates to the field of unmanned aerial vehicles and, more particularly, to a flight control method and a flight control device for a multi-rotor unmanned aerial vehicle, and a multi-rotor unmanned aerial vehicle.

### BACKGROUND

Unmanned aerial vehicles (UAVs) are often used in aerial photography, remote aerial monitoring, surveillance, reconnaissance, or other occasions. A multi-rotor unmanned aerial vehicle is a special unmanned aerial vehicle with three or more rotor shafts. A rotor in each shaft is driven to rotate by a motor on the shaft to generate propulsion.

Existing multi-rotor unmanned aerial vehicles may generally carry aerial gimbals, spraying devices, or other carriers. However, these carriers are generally mounted on a lower side of the frames. For example, aerial gimbals are located at the lower side of the frame, and most of the shooting angles are from the sky overlooking the ground. This is not applicable when an upward shooting is needed, e.g., when detecting bridge bottom flaws under the bridge. Some aerial gimbals can be mounted on an upper side of the frame of a multi-rotor unmanned aerial vehicles. However, this requires an additional mounting mechanism on the upper side of the frame, which will cause large overall weight redundancy that is unsuitable for the unmanned aerial vehicle.

### SUMMARY

One aspect of the present disclosure provides a flight control method for a multi-rotor unmanned aerial vehicle. The vehicle includes a center frame; a carrier mounted on the center frame; a plurality of arms connected to the center frame; and a propulsion assembly on each of the plurality of arms for providing flight propulsion. Each propulsion assembly includes a forward-rotating rotor and a counter-rotating rotor arranged vertically in a direction of a yaw axis, a first driving device for driving the forward-rotating rotor to rotate, and a second driving device for driving the counter-rotating rotor to rotate. The forward-rotating rotor and the counter-rotating rotor have rotating centers in a same axis and have opposite rotating direction. The method includes: determining a current attitude of the multi-rotor unmanned aerial vehicle; and adjusting vertical arrangement positions of the forward-rotating rotor and the counter-rotating rotor of each propulsion assembly in the direction of the yaw axis according to the current attitude of the multi-rotor unmanned aerial vehicle. The current attitude of the multi-rotor unmanned aerial vehicle includes a normal flight attitude when the carrier is at the lower side of the center frame, and an inverted flight attitude when the carrier is at the upper side of the center frame. In the normal and inverted flight attitudes, an installation position of the carrier on the center frame is same. The vertical arrangement positions of the forward-rotating rotor and the counter-rotating rotor of each propulsion assembly are adjusted such that the vertical arrangement positions of the forward-rotating rotor and the counter-rotating rotor in each propulsion assembly in the direction of the yaw axis remain unchanged and each rotor maintains a state of pushing down airflow when the rotor rotates.

In the flight control method provided by various embodiments of the present disclosure, the vertical arrangement positions of the forward-rotating rotors and the counter-rotating rotors in the propulsion assemblies of the multi-rotor unmanned aerial vehicle may be adjusted according to the current attitude of the multi-rotor unmanned aerial vehicle. Correspondingly, when the multi-rotor unmanned aerial vehicle is in the normal flight attitude where the carrier is located at the lower side of the center frame and in the inverted flight attitude where the carrier is located at the upper side of the center frame, the vertical arrangement positions of the forward-rotating rotor and the counter-rotating rotor in each propulsion assembly in the direction of the yaw axis may remain unchanged, and each rotor may be kept in a state that pushes the airflow downward when the rotor rotates. The installation position of the carrier on the center frame may remain unchanged. Correspondingly, there may be no need to change the installation position of the carrier on the center frame or dispose additional mounting devices on the upper side of the center frame to mount the carrier. The carrier of the multi-rotor unmanned aerial vehicle may achieve the corresponding function in the top or bottom view angles directly through the normal flight attitude and the inverted flight attitude of the multi-rotor unmanned aerial vehicle.

Another aspect of the present disclosure provides a flight control device for a multi-rotor unmanned aerial vehicle. The vehicle includes: a center frame; a carrier mounted on the center frame; a plurality of arms connected to the center frame; and a propulsion assembly on each of the plurality of arms for providing flight propulsion. Each propulsion assembly includes a forward-rotating rotor and a counter-rotating rotor arranged vertically in a direction of a yaw axis, a first driving device for driving the forward-rotating rotor to rotate, and a second driving device for driving the counter-rotating rotor to rotate. The forward-rotating rotor and the counter-rotating rotor have rotating centers in a same axis and opposite rotating direction. The flight control device includes a determining module and an adjustment module. The determining module is configured to determine a current attitude of the multi-rotor unmanned aerial vehicle. The current attitude of the multi-rotor unmanned aerial vehicle includes a normal flight attitude when the carrier is at the lower side of the center frame, and an inverted flight attitude when the carrier is at the upper side of the center frame. In the normal and inverted flight attitude, an installation position of the carrier on the center frame remains unchanged. The adjustment module is configured to adjust the vertical arrangement positions of the forward-rotating rotor and the counter-rotating rotor of each propulsion assembly in the direction of the yaw axis according to the current attitude of the multi-rotor unmanned aerial vehicle, such that the vertical arrangement positions of the forward-rotating rotor and the counter-rotating rotor in each propulsion assembly in the direction of the yaw axis remain unchanged and each rotor maintains a state of pushing down airflow when the rotor rotates.

In the flight control device provided by various embodiments of the present disclosure, the vertical arrangement positions of the forward-rotating rotors and the counter-rotating rotors in the propulsion assemblies of the multi-rotor unmanned aerial vehicle may be adjusted according to the current attitude of the multi-rotor unmanned aerial vehicle. Correspondingly, when the multi-rotor unmanned aerial vehicle is in the normal flight attitude where the carrier is located at the lower side of the center frame and in the inverted flight attitude where the carrier is located at the upper side of the center frame, the vertical arrangement positions of the forward-rotating rotor and the counter-rotating rotor in each propulsion assembly in the direction of the yaw axis may remain unchanged, and each rotor may be kept in a state that pushes the airflow downward when the rotor rotates. The installation position of the carrier on the center frame may remain unchanged. Correspondingly, there may be no need to change the installation position of the carrier on the center frame or dispose additional mounting devices on the upper side of the center frame to mount the carrier. The carrier of the multi-rotor unmanned aerial vehicle may achieve the corresponding function in the top or bottom view angles directly through the normal flight attitude and the inverted flight attitude of the multi-rotor unmanned aerial vehicle.

Another aspect of the present disclosure provides a multi-rotor unmanned aerial vehicle. The multi-rotor unmanned aerial vehicle includes: a center frame; a carrier mounted on the center frame; a plurality of arms connected to the center frame; a propulsion assembly on each of the plurality of arms for providing flight propulsion; and a flight control device. Each propulsion assembly includes a forward-rotating rotor and a counter-rotating rotor arranged vertically in a direction of a yaw axis, a first driving device for driving the forward-rotating rotor to rotate, and a second driving device for driving the counter-rotating rotor to rotate. The forward-rotating rotor and the counter-rotating rotor have rotating centers in a same axis and opposite rotating direction. The flight control device is configured to determine a current attitude of the multi-rotor unmanned aerial vehicle, and adjust vertical arrangement positions of the forward-rotating rotor and the counter-rotating rotor of each propulsion assembly in the direction of the yaw axis according to the current attitude of the multi-rotor unmanned aerial vehicle. The current attitude of the multi-rotor unmanned aerial vehicle includes a normal flight attitude when the carrier is at the lower side of the center frame, and an inverted flight attitude when the carrier is at the upper side of the center frame. In the normal and inverted flight attitude, an installation position of the carrier on the center frame is same. The flight control device adjusts the vertical arrangement positions of the forward-rotating rotor and the counter-rotating rotor of each propulsion assembly in the direction of the yaw axis according to the current attitude of the multi-rotor unmanned aerial vehicle, such that the vertical arrangement position of the forward-rotating rotor and the counter-rotating rotor in each propulsion assembly in the direction of the yaw axis remain unchanged each rotor maintains a state of pushing down airflow when the rotor rotates.

In the present disclosure, the vertical arrangement positions of the forward-rotating rotors and the counter-rotating rotors in the propulsion assemblies of the multi-rotor unmanned aerial vehicle may be adjusted according to the current attitude of the multi-rotor unmanned aerial vehicle. Correspondingly, when the multi-rotor unmanned aerial vehicle is in the normal flight attitude when the carrier is located at the lower side of the center frame and in the inverted flight attitude when the carrier is located at the upper side of the center frame, the vertical arrangement positions of the forward-rotating rotor and the counter-rotating rotor in each propulsion assembly in the direction of the yaw axis may be maintained unchanged, and each rotor may be kept in a state that pushes the airflow downward when the rotor rotates. The installation position of the carrier on the center frame may be unchanged. Correspondingly, there may be no need to change the installation position of the carrier on the center frame or dispose additional mounting devices on the upper side of the center frame to mount the carrier. The carrier of the multi-rotor unmanned aerial vehicle may achieve the corresponding function in the top or bottom view angles directly through the normal flight attitude and the inverted flight attitude of the multi-rotor unmanned aerial vehicle. Good control of the multi-rotor unmanned aerial vehicle may be achieved in the normal flight attitude and in the inverted flight attitude, and photographing in multiple angles or other functions may be achieved with the multi-rotor unmanned aerial vehicle.

Other aspects or embodiments of the present disclosure can be understood by those skilled in the art in light of the description, the claims, and the drawings of the present disclosure.

### BRIEF DESCRIPTION OF THE DRAWINGS

FIG. 1 illustrates an exemplary multi-rotor unmanned aerial vehicle consistent with various embodiment of the present disclosure;

FIG. 2 illustrates an exemplary flight control method for a multi-rotor unmanned aerial vehicle consistent with various embodiment of the present disclosure;

FIG. 3 illustrates an exemplary state of a multi-rotor unmanned aerial vehicle in normal flight consistent with various embodiment of the present disclosure;

FIG. 4 illustrates an exemplary multi-rotor unmanned aerial vehicle inverted only consistent with various embodiment of the present disclosure;

FIG. 5 illustrates an exemplary status of a multi-rotor unmanned aerial vehicle based on FIG. 4 in inverted flight using a flight control method consistent with various embodiment of the present disclosure;

FIG. 6 illustrates another exemplary status of a multi-rotor unmanned aerial vehicle based on FIG. 4 in inverted flight using a flight control method consistent with various embodiment of the present disclosure;

FIG. 7 illustrates another exemplary flight control method for a multi-rotor unmanned aerial vehicle consistent with various embodiment of the present disclosure;

FIG. 8 illustrates an exemplary flight control device for a multi-rotor unmanned aerial vehicle consistent with various embodiment of the present disclosure;

FIG. 9 illustrates another exemplary flight control device for a multi-rotor unmanned aerial vehicle consistent with various embodiment of the present disclosure;

FIG. 10 illustrates another exemplary flight control device for a multi-rotor unmanned aerial vehicle consistent with various embodiment of the present disclosure; and

FIG. 11 illustrates another exemplary flight control device for a multi-rotor unmanned aerial vehicle consistent with various embodiments of the present disclosure.

### DETAILED DESCRIPTION OF THE EMBODIMENTS

Reference will now be made in detail to exemplary embodiments of the disclosure, which are illustrated in the accompanying drawings. Wherever possible, the same reference numbers will be used throughout the drawings to refer to the same or like parts.

Example embodiments will be described with reference to the accompanying drawings, when the same numbers refer to the same or similar elements unless otherwise specified.

As used herein, when a first component is referred to as “fixed to” a second component, it is intended that the first component may be directly attached to the second component or may be indirectly attached to the second component via another component. When a first component is referred to as “connecting” to a second component, it is intended that the first component may be directly connected to the second component or may be indirectly connected to the second component via a third component between them. The terms “perpendicular,” “horizontal,” “left,” “right,” and similar expressions used herein are merely intended for description.

Unless otherwise defined, all the technical and scientific terms used herein have the same or similar meanings as generally understood by one of ordinary skill in the art. As described herein, the terms used in the specification of the present disclosure are intended to describe example embodiments, instead of limiting the present disclosure. The term “and/or” used herein includes any suitable combination of one or more related items listed.

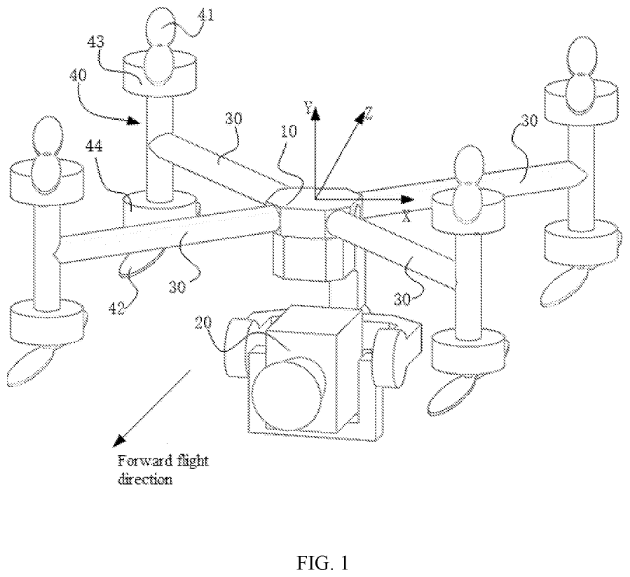

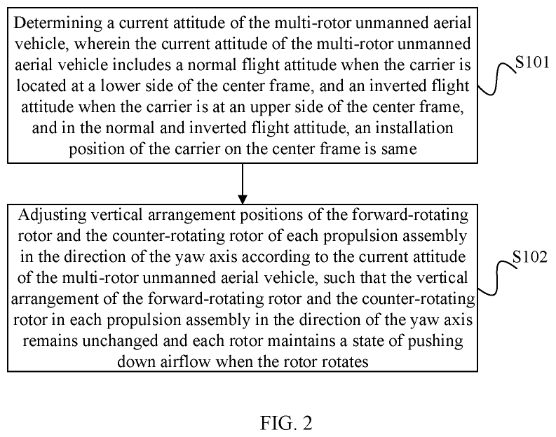

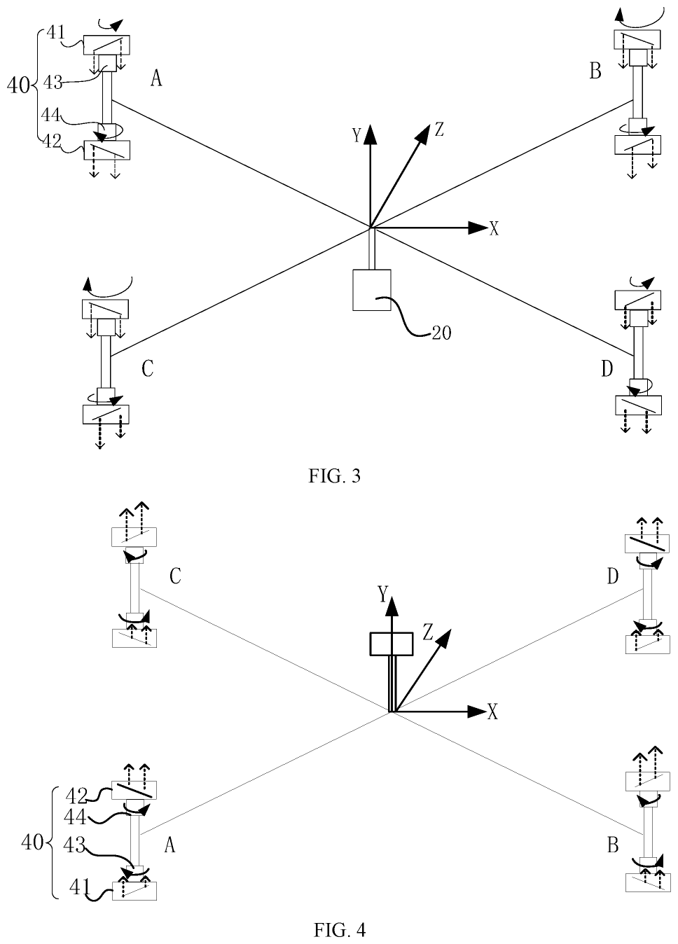

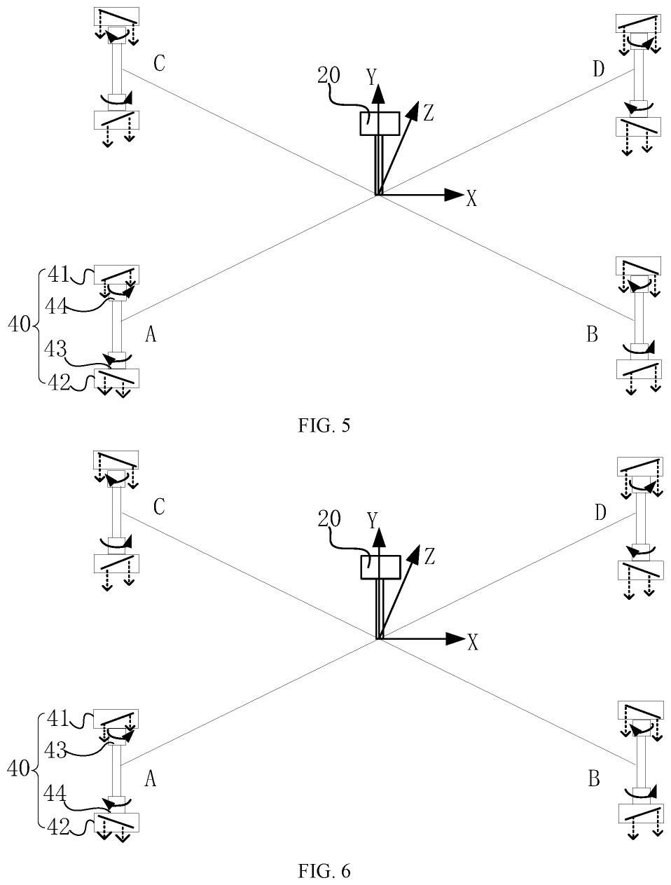

One embodiment of the present disclosure provides a flight control method for a multi-rotor unmanned aerial vehicle. FIG. 1 illustrates an exemplary multi-rotor unmanned aerial vehicle; FIG. 2 illustrates an exemplary flight control method for a multi-rotor unmanned aerial vehicle; FIG. 3 illustrates an exemplary status of a multi-rotor unmanned aerial vehicle in a normal flight; FIG. 4 illustrates an exemplary multi-rotor unmanned aerial vehicle that is inverted only; FIG. 5 illustrates an exemplary status of a multi-rotor unmanned aerial vehicle in an inverted flight based on FIG. 4; and FIG. 6 illustrates another exemplary status of a multi-rotor unmanned aerial vehicle in the inverted flight based on FIG. 4 using a flight control method.

The present embodiment of the present disclosure provides a flight control method for a multi-rotor unmanned aerial vehicle. The method may be applied to a multi-rotor unmanned aerial vehicle. As illustrated in FIG. 1, the multi-rotor unmanned aerial vehicle may include: a center frame 10, a carrier 20 mounted on the center frame 10, a plurality of arms 30 connected to the center frame 10, and a propulsion assembly 40 on each of the plurality of arms 30 for providing flight propulsion.

The plurality of arms 30 may extend out radially from the center frame 10. The multi-rotor unmanned aerial vehicle may further include a tripod (not shown in the figures) connected to the center frame 10 for supporting the multi-rotor unmanned aerial vehicle when landing.

The multi-rotor unmanned aerial vehicle may wirelessly communicate with a control device and a display device. The multi-rotor unmanned aerial vehicle may perform instructions from the control device, and the display device may display the status of the multi-rotor unmanned aerial vehicle and images photographed by the multi-rotor unmanned aerial vehicle.

Each propulsion assembly 40 may include a forward-rotating rotor 41 and a counter-rotating rotor 42. In each propulsion assembly 40, the forward-rotating rotor 41 and the counter-rotating rotor 42 may be disposed up and down in a direction of a yaw axis. Each propulsion assembly 40 may further include a first driving device 43 for driving the forward-rotating rotor 41 and a second driving device 44 for driving the counter-rotating rotor 42. A center of rotation of the forward-rotating rotor 41 and a center of rotation of the counter-rotating rotor 42 may be coaxial. A direction of rotation of the forward-rotating rotor 41 and a direction of rotation of the counter-rotating rotor 42 may be opposite. The forward-rotating rotor 41 and the counter-rotating rotor 42 may be disposed up and down in a direction of a yaw axis, and may have opposite rotation directions. The forward-rotating rotor 41 and the counter-rotating rotor 42 may rotate with a same speed. The torque applied to the multi-rotor unmanned aerial vehicle by the forward-rotating rotor 41 and the counter-rotating rotor 42 may be canceled by each other, to ensure a balance of the multi-rotor unmanned aerial vehicle. In the case of a same projected area, compared with the arrangement of only one layer, the rotors of the double-layered propulsion assembly can provide propulsion larger than one rotor.

Each rotor may correspond to one driving device. The first driving device 43 and the second driving device 44 in one propulsion assembly may be motors. The motors may be disposed between electronic governors and the rotors. Each motor and one corresponding rotor may be disposed on one corresponding arm. The electronic governors may receive driving signals from the flight controller and provide driving currents to the motors according to the driving signals for controlling the rotation speed of the motors. The motors may drive the rotors to rotate for providing flight propulsion to the multi-rotor unmanned aerial vehicle. The propulsion may enable the multi-rotor unmanned aerial vehicle to move with one or more degrees of freedom. In some embodiments, the multi-rotor unmanned aerial vehicle may rotate about one or more rotation axes. For example, the rotation axis may include a pitch axis (X), a yaw axis (Y), and a roll axis (Z). It should be understood that each motor may be a DC motor or an AC motor. In addition, the motor may be a brushless motor or a brushed motor.

In this embodiment, the plurality of arms 30 may include three or more arms. Each arm 30 may be provided with a propulsion assembly 40. For example, the entire multi-rotor unmanned aerial vehicle can be 3 shafts 6 rotors, 4 shafts 8 rotors, 6 shafts 12 rotors, 8 shafts 16 rotors, and so on.

The flight control method for the multi-rotor unmanned aerial vehicle may include:

S101: determining a current attitude of the multi-rotor unmanned aerial vehicle; and

S102: adjusting vertical arrangement positions of the forward-rotating rotors and the counter-rotating rotors in the direction of the yaw axis according to the current attitude of the multi-rotor unmanned aerial vehicle.

The current attitude of the multi-rotor unmanned aerial vehicle may include a normal flight attitude where the carrier 20 is located at a lower side of the center frame 10, and an inverted flight attitude where the carrier 20 is located at an upper side of the center frame 10. In the normal and inverted flight attitudes, installation positions of the carrier 20 on the center frame 10 may remain unchanged.

Determining the current attitude of the multi-rotor unmanned aerial vehicle can detect the position of the carrier 20 relative to the center frame 10. When it is detected that the carrier 20 is located at the lower side of the center frame 10, it may be determined that the current attitude of the multi-rotor unmanned aerial vehicle is the normal flight attitude. When it is detected that the carrier 20 is located at the upper side of the center frame 10, it may be determined that the current attitude of the multi-rotor unmanned aerial vehicle is the inverted flight attitude.

In another embodiment, the multi-rotor unmanned aerial vehicle can also receive the normal or inverted flight instructions sent by the control device. When the normal flight instruction is received and the multi-rotor unmanned aerial vehicle responds to the normal flight instruction, the current attitude may be determined to be the normal flight attitude; and when the inverted flight instruction is received and the multi-rotor unmanned aerial vehicle responds to the inverted flight instruction, the current attitude may be determined to be the inverted flight attitude.

In one embodiment, the method may further include: controlling the multi-rotor unmanned aerial vehicle to change from a normal flight attitude control mode to an inverted flight attitude control mode when inverting the center frame 10 to invert the carrier 20 from a position at the lower side of the center frame 10 to a position at the upper side of the center frame 10; or controlling the multi-rotor unmanned aerial vehicle to change from the inverted flight attitude control mode to the normal flight attitude control mode when inverting the center frame 10 to invert the carrier 20 from the position at the upper side of the center frame 10 to the position at the lower side of the center frame 10.

A change mode of a movement of the multi-rotor unmanned aerial vehicle controlled by the normal flight attitude control mode may be different from a change mode of the movement of the multi-rotor unmanned aerial vehicle controlled by the inverted flight attitude control mode.

The center frame 10 can be inverted by 180 degrees, so that the multi-rotor unmanned aerial vehicle can switch between the normal and the inverted flight attitudes.

FIG. 3 illustrates an exemplary status of a multi-rotor unmanned aerial vehicle in a normal flight. For description purposes only, the embodiment in FIG. 3 where the multi-rotor unmanned aerial vehicle includes 4 shafts 8 rotors is used as an example to illustrate the present disclosure and should not limit the scopes of the present disclosure. As illustrated in FIG. 3, the multi-rotor unmanned aerial vehicle may include four propulsion assemblies labeled as A, B, C, and D in FIG. 3 respectively. A rotor rotating counter-clockwise to provide downward propulsion may be a forward-rotating rotor, and a rotor rotating clockwise to provide downward propulsion may be a counter-rotating rotor. Directions of rotation referred to in this embodiment are based on that the top view angle as the viewing angle, and FIG. 3 shows the status in the normal flight. Taking the propulsion assembly A as an example, along the direction parallel to the yaw axis Y, an upper rotor may be a forward-rotating rotor 41 and a lower rotor may be a counter-rotating rotor 42. The first driving device 43 of the forward-rotating rotor 41 drives the forward-rotating rotor to rotate counterclockwise. Arc arrows in the figure indicate the rotation direction of the rotors driven by the driving devices. The dotted arrows indicate the direction of the airflow. The rotors may push the airflow downward when they rotate. The air may provide inverted force and the propulsion to the rotors. When the rotating speed of the rotors is larger, the propulsion may be larger. When the overall propulsion of the multi-rotor unmanned aerial vehicle is greater than gravity, the multi-rotor unmanned aerial vehicle may rise; when the overall propulsion of the multi-rotor unmanned aerial vehicle is equal to gravity, the multi-rotor unmanned aerial vehicle may be hovering; when the overall propulsion of the multi-rotor unmanned aerial vehicle is less than gravity, the multi-rotor unmanned aerial vehicle may dropdown. To ensure that the multi-rotor unmanned aerial vehicle can fly normally, it is necessary to ensure that each rotor should push down the airflow when it rotates so that each rotor can generate upward propulsion.

FIG. 4 illustrates an exemplary multi-rotor unmanned aerial vehicle being inverted only. As illustrated in FIG. 4, the multi-rotor unmanned aerial vehicle based on FIG. 3 may be inverted by 180 degrees from front to back, such that the carrier 20 is inverted to the position at the upper side of the center frame 10 and the multi-rotor unmanned aerial vehicle is in the inverted flight attitude. The multi-rotor unmanned aerial vehicle after being inverted only is shown in FIG. 4. Take the propulsion assembly A as an example, after the inversion, the forward-rotating rotor 41 may be located in a lower position parallel to the yaw axis Y. Correspondingly, the rotating direction of the first driving device 43 that drives the forward-rotating rotor to rotate may become clockwise, and becomes inconsistent with the preset rotation direction of the forward-rotating rotor 41. Therefore, if rotating in this state, the airflow generated by the forward-rotating rotor 41 when the forward-rotating rotor 41 rotates may become upwards (as shown by the dotted arrows in FIG. 4). The counter-rotating rotor 42 may be located at an upper position in a direction parallel to the yaw axis Y. The rotation direction of the second driving device 44 that drives the rotation of the counter-rotating rotor 42 may become counterclockwise, and may be inconsistent with the preset rotating direction of the counter-rotating rotor 42. Therefore, if the rotation is performed in this state, the airflow generated by the counter-rotating rotor 42 when the counter-rotating rotor 42 rotates may be upward (as shown by the dotted arrows in FIG. 4). The same is true for the other propulsion assemblies B, C, and D, which will not be repeated here. For details, please be referred to FIG. 4. Correspondingly, each propulsion assembly cannot provide upward propulsion, and the multi-rotor unmanned aerial vehicle cannot fly normally.

In S102, the vertical arrangement positions of the forward-rotating rotors 41 and the counter-rotating rotors 42 in the direction of the yaw axis may be adjusted according to the current attitude of the multi-rotor unmanned aerial vehicle shown in FIG. 4, such that the vertical arrangement positions of the forward-rotating rotor 41 and the counter-rotating rotor 42 in each propulsion assembly in the direction parallel to the yaw axis Y remain unchanged and each rotor maintains a state of pushing down the airflow when the rotor rotates.

In one embodiment, the forward-rotating rotors 41 and the counter-rotating rotors 42 may be detachably connected to the corresponding driving devices.

Correspondingly, adjusting the vertical arrangement positions of the forward-rotating rotors 41 and the counter-rotating rotors 42 in the direction of the yaw axis according to the current attitude of the multi-rotor unmanned aerial vehicle may include: when the multi-rotor unmanned aerial vehicle is switched from the normal flight attitude to the inverted flight attitude or from the inverted flight attitude to the normal flight attitude, adjusting the installation positions of the forward-rotating rotor 41 and the counter-rotating rotor 42 on each propulsion assembly 40 to interchange the forward-rotating rotor 41 and the counter-rotating rotor 42 on the propulsion assembly 40.

FIG. 5 illustrates an exemplary status of a multi-rotor unmanned aerial vehicle in the inverted flight based on FIG. 4 using a flight control method consistent with various embodiments of the present disclosure. As illustrated in FIG. 5, the installation positions of the forward-rotating rotor 41 and the counter-rotating rotor 42 in a same propulsion assembly 40 (for example, the propulsion assembly A) may be interchanged. After being interchanged, the forward-rotating rotor 41 may be located at an upper position in the direction parallel to the yaw axis Y, and may be connected to the second driving device 44. The second driving device 44 may correspondingly drive the forward-rotating rotor 41 to rotate. The second driving device 44 may rotate counterclockwise to drive the forward-rotating rotor 41 rotate counterclockwise, and the preset rotation direction of the forward-rotating rotor 41 may be consistent with the rotation direction of the second driving device 44. Therefore, the forward-rotating rotor 41 may push the airflow downward when rotating. The counter-rotating rotor 42 may be located at a lower position in the direction parallel to the yaw axis Y, and may be connected to the first driving device 43 after being interchanged. The first driving device 43 may drive the counter-rotating rotor 42 to rotate. The first driving device 43 may rotate clockwise to drive the counter-rotating rotor 42 rotate clockwise, and the preset rotation direction of the counter-rotating rotor 42 may be consistent with the rotation direction of the first driving device 43. Therefore, the counter-rotating rotor 42 may push the airflow downward when rotating.

The other propulsion assemblies B, C, and D may be operated in a way similar to the propulsion assembly A. For one propulsion assembly, after the installation positions of the forward-rotating rotor 41 and the counter-rotating rotor 42 are interchanged, the vertical arrangement positions of the forward-rotating rotors 41 and the counter-rotating rotors 42 in the direction of the yaw axis may be still maintained. For example, in the propulsion assembly A, the forward-rotating rotor 41 may be always located at the upper position and the counter-rotating rotor 42 may be always located at the lower position, in both the normal and inverted flight attitudes. This may ensure that the multi-rotor unmanned aerial vehicle can fly normally in the normal and inverted flight attitudes.

In another embodiment, for each arm, the propulsion assembly on the arm may be rotatably or detachably connected to the arm.

Correspondingly, adjusting the vertical arrangement positions of the forward-rotating rotors 41 and the counter-rotating rotors 42 in the direction of the yaw axis according to the current attitude of the multi-rotor unmanned aerial vehicle may include: when the multi-rotor unmanned aerial vehicle is switched from the normal flight attitude to the inverted flight attitude or from the inverted flight attitude to the normal flight attitude, controlling movement of each propulsion assembly 40 relative to a corresponding arm, such that each propulsion assembly 40 maintains a status same as in the normal flight.

The same status as in the normal flight attitude may mean that a corresponding relationship between each driving device and a corresponding rotor remains unchanged, and the direction of rotation is unchanged, and the up and down position of each rotor also remains unchanged. FIG. 6 illustrates another exemplary status of a multi-rotor unmanned aerial vehicle in the inverted fight based on FIG. 4 using a flight control method consistent with various embodiments of the present disclosure. When the center frame 10 is inverted by 180 degrees to the state in FIG. 4, each propulsion assembly (for example, the propulsion assembly A) may be inverted around a corresponding arm to a status same as in the normal flight in FIG. 3. The forward-rotating rotor 41 may be located at an upper position in the direction parallel to the yaw axis Y. The first driving device 43 may drive the forward-rotating rotor 41 to rotate counterclockwise. The preset rotation direction of the forward-rotating rotor 41 may be consistent with the rotation direction of the first driving device 43. When the forward-rotating rotor 41 rotates, it may push the airflow downward. The counter-rotating rotor 42 may be located at a lower position in the direction parallel to the yaw axis Y. The second drive device 44 may drive the counter-rotating rotor 42 to rotate clockwise. The preset rotation direction of the counter-rotating rotor 42 may be consistent with the rotation direction of the second drive device 44. The counter-rotating rotor 42 may push the airflow downward when rotating.

The other propulsion assemblies B, C, and D may be operated in a way similar to the propulsion assembly A. After each propulsion assembly 40 moves to the same status as in the normal flight attitude, for one propulsion assembly, the vertical arrangement positions of the forward-rotating rotors 41 and the counter-rotating rotors 42 in the direction of the yaw axis may be still maintained. For example, in the propulsion assembly A, the forward-rotating rotor 41 may be always driven by the first driving device 43 and the counter-rotating rotor 42 may be always driven by the second driving device 44. The forward-rotating rotor 41 may be always located at the upper position and the counter-rotating rotor 42 may be always located at the lower position, in both the normal and inverted flight attitudes. This may ensure that the multi-rotor unmanned aerial vehicle can fly normally in the normal and inverted flight attitudes.

In another embodiment, each arm may be rotatably or detachably connected to the center frame 10.

Correspondingly, adjusting the vertical arrangement positions of the forward-rotating rotors 41 and the counter-rotating rotors 42 in the direction of the yaw axis according to the current attitude of the multi-rotor unmanned aerial vehicle may include: when the center frame is inverted to convert the multi-rotor unmanned aerial vehicle from the normal flight attitude to the inverted flight attitude or from the inverted flight attitude to the normal flight attitude, controlling each arm to move relative to the center frame, such that each propulsion assembly 40 maintains a status same as in the normal flight. The method may be achieved in a way similar to the previous embodiment.

When the multi-rotor unmanned aerial vehicle is switched from the inverted flight attitude to the normal flight attitude, the vertical arrangement positions of the forward-rotating rotors 41 and the counter-rotating rotors 42 in the direction of the yaw axis may be adjusted similarly, to ensure that each rotor provides propulsion.

The carrier 20 may include at least one of a gimbal device, a spraying device, a cargo-carrying device, or a weapon device. By adopting the flight control method of the multi-rotor unmanned aerial vehicle provided by the present disclosure, it is possible to use a gimbal device to photograph from a top view, or from an upward angle. It is also possible to use a spray device to spray from a top view, or from an upward angle, such as to spray pesticides. The cargo-carrying device may be configured to implement multiple forms of cargo loading. The weapon device may be configured to achieve weapon launch in multiple angels, such as to fire bullets. Of course, the specific type of the carrier 20 in practical applications may not be limited to the types provided above, and may be specifically selected according to actual needs, which is not particularly limited in this embodiment.

In the flight control method for the multi-rotor unmanned aerial vehicle provided by the present disclosure, the vertical arrangement positions of the forward-rotating rotors and the counter-rotating rotors in the propulsion assemblies of the multi-rotor unmanned aerial vehicle may be adjusted according to the current attitude of the multi-rotor unmanned aerial vehicle. Correspondingly, when the multi-rotor unmanned aerial vehicle is in the normal flight attitude when the carrier is located at the lower side of the center frame and in the inverted flight attitude when the carrier is located at the upper side of the center frame, the vertical arrangement positions of the forward-rotating rotor and the counter-rotating rotor in each propulsion assembly in the direction of the yaw axis may remain unchanged, and each rotor may maintain a state of pushing the airflow downward when the rotor rotates. The installation position of the carrier on the center frame may be unchanged. Correspondingly, there may be no need to change the installation position of the carrier on the center frame or dispose extra mounting devices on the upper side of the center frame to mount the carrier. The carrier of the multi-rotor unmanned aerial vehicle may achieve the corresponding function in the top or bottom view angles directly through the normal flight attitude and the inverted flight attitude of the multi-rotor unmanned aerial vehicle.

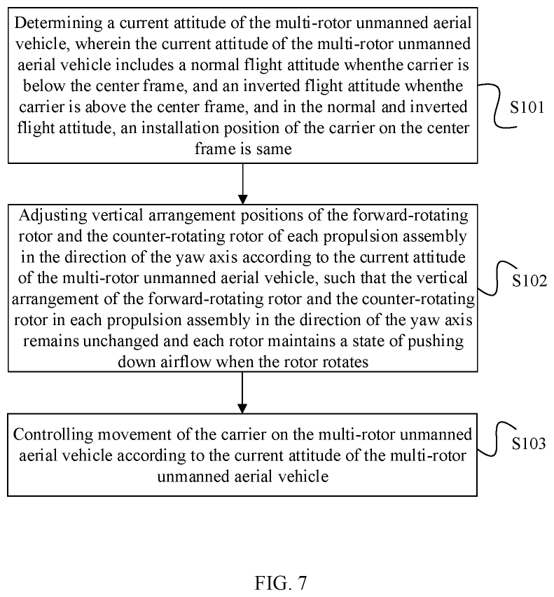

In another embodiment illustrated in FIG. 7, based on the flight control method in FIG. 2 described above, the flight control method may further include:

S103: controlling a movement of the carrier on the multi-rotor unmanned aerial vehicle according to the current attitude of the multi-rotor unmanned aerial vehicle.

When the multi-rotor unmanned aerial vehicle is in the normal flight attitude, the carrier of the multi-rotor unmanned aerial vehicle may be controlled to move in a first control mode. When the multi-rotor unmanned aerial vehicle is in the inverted flight attitude, the carrier of the multi-rotor unmanned aerial vehicle may be controlled to move in a second control mode.

A change mode of the movement of the carrier controlled by the first control mode may be different from a change mode of the movement of the carrier controlled by the second control mode.

After the multi-rotor unmanned aerial vehicle is inverted, its control orientation may change. For example, for each rotation shaft and a same control instruction, the control device may control a corresponding rotary shaft mechanism to rotate clockwise around a corresponding rotating axis when the multi-rotor unmanned aerial vehicle is in the normal flight attitude, and may control the corresponding rotary shaft mechanism to rotate counterclockwise around the corresponding rotating axis when the multi-rotor unmanned aerial vehicle is in the inverted flight attitude.

When the carrier is a gimbal device for photographing an object on the ground, if the multi-rotor unmanned aerial vehicle is in the normal flight attitude, a user may input a control instruction through a manipulation device, and the control instruction may make the gimbal device rotate counterclockwise around the pitch axis X. For example, the user may rotate a pull-wheel on the manipulation device clockwise, and the control device may control the gimbal device to rotate counterclockwise around the pitch axis X using a first control mode. Correspondingly, the photographing device may move away from the center frame 10 to point at the photographing object on the ground. If the multi-rotor unmanned aerial vehicle is in the inverted flight attitude, the user may still input the control instruction that will make the gimbal device rotate counterclockwise around the pitch axis X according to habit, for example, by rotating the pull-wheel on the manipulation device counterclockwise. The control device may control the gimbal device to rotate clockwise around the pitch axis X using a second control mode. Correspondingly, the photographing device may move close to the center frame 10 to point at the photographing object on the ground.

When the gimbal device photographs in the bottom view angle, the gimbal device may need to move away from the center frame 10 in the inverted flight attitude. The user may generate the control instruction making the gimbal device rotate clockwise around the pitch axis X. The control device may control the gimbal device to rotate counterclockwise around the pitch axis X using the second control mode. Correspondingly, the photographing device may move away from the center frame 10 to point at the photographing object in the bottom view angle.

In the flight control method for the multi-rotor unmanned aerial vehicle provided by the present disclosure, the vertical arrangement positions of the forward-rotating rotors and the counter-rotating rotors in the propulsion assemblies of the multi-rotor unmanned aerial vehicle may be adjusted according to the current attitude of the multi-rotor unmanned aerial vehicle. Correspondingly, when the multi-rotor unmanned aerial vehicle is in the normal flight attitude where the carrier is located at the lower side of the center frame and in the inverted flight attitude where the carrier is located at the upper side of the center frame, the vertical arrangement positions of the forward-rotating rotor and the counter-rotating rotor in each propulsion assembly in the direction of the yaw axis may remain unchanged, and each rotor may maintain a state of pushing the airflow downward when the rotor rotates. The installation position of the carrier on the center frame may remain unchanged. Correspondingly, there may be no need to change the installation position of the carrier on the center frame or dispose extra mounting devices on the upper side of the center frame to mount the carrier. The carrier of the multi-rotor unmanned aerial vehicle may achieve the corresponding function in the top or bottom view angles directly through the normal flight attitude and the inverted flight attitude of the multi-rotor unmanned aerial vehicle. Good control of the multi-rotor unmanned aerial vehicle may be achieved in the normal flight attitude and in the inverted flight attitude, and photographing in multiple angles or other functions may be achieved with the multi-rotor unmanned aerial vehicle.

The present disclosure also provides a flight control device for a multi-rotor unmanned aerial vehicle. The flight control device may be configured to control the multi-rotor unmanned aerial vehicle. As illustrated in FIG. 1, the multi-rotor unmanned aerial vehicle may include: a center frame 10, a carrier 20 mounted on the center frame 10, a plurality of arms 30 connected to the center frame 10, and a propulsion assembly 40 on each of the plurality of arms 30 for providing flight propulsion.

The plurality of arms 30 may extend out radially from the center frame 10. The multi-rotor unmanned aerial vehicle may further include a tripod (not shown in the figures) connected to the center frame 10 for supporting the multi-rotor unmanned aerial vehicle when landing.

The multi-rotor unmanned aerial vehicle may wirelessly communicate with a control device and a display device. The multi-rotor unmanned aerial vehicle may perform instructions from the control device, and the display device may display the status of the multi-rotor unmanned aerial vehicle and images photographed by the multi-rotor unmanned aerial vehicle.

Each propulsion assembly 40 may include a forward-rotating rotor 41 and a counter-rotating rotor 42. In each propulsion assembly 40, the forward-rotating rotor 41 and the counter-rotating rotor 42 may be disposed up and down in a direction of a yaw axis. Each propulsion assembly 40 may further include a first driving device 43 for driving the forward-rotating rotor 41 and a second driving device 44 for driving the counter-rotating rotor 42. A center of rotation of the forward-rotating rotor 41 and a center of rotation of the counter-rotating rotor 42 may be coaxial. A direction of rotation of the forward-rotating rotor 41 and a direction of rotation of the counter-rotating rotor 42 may be opposite to each other. The forward-rotating rotor 41 and the counter-rotating rotor 42 may be disposed up and down in a direction of a yaw axis, and may have opposite rotation direction. The forward-rotating rotor 41 and the counter-rotating rotor 42 may rotate with a same speed. Torque applied to the multi-rotor unmanned aerial vehicle by the forward-rotating rotor 41 and the counter-rotating rotor 42 may be canceled by each other, to ensure a balance of the multi-rotor unmanned aerial vehicle. In the case of a same projected area, compared with the arrangement of only one layer, the rotors of the double-layered propulsion assembly can provide propulsion larger than one rotor.

Each rotor may correspond to one driving device. The first driving device 43 and the second driving device 44 in one propulsion assembly may be motors. The motors may be disposed between electronic governors and the rotors. Each motor and one corresponding rotor may be disposed on one corresponding arm. The electronic governors may receive driving signals from the flight controller and provide driving currents to the motors according to the driving signals for controlling the rotation speed of the motors. The motors may drive the rotors to rotate for providing flight propulsion to the multi-rotor unmanned aerial vehicle. The propulsion may enable the multi-rotor unmanned aerial vehicle to move with one or more degrees of freedom. In some embodiments, the multi-rotor unmanned aerial vehicle may rotate about one or more rotation axes. For example, the rotation axis may include a pitch axis (X), a yaw axis (Y), and a roll axis (Z). It should be understood that each motor may be a DC motor or an AC motor. In addition, the motor may be a brushless motor or a brushed motor.

In this embodiment, the plurality of arms 30 may include three or more arms. Each arm 30 may be provided with a propulsion assembly 40. For example, the entire multi-rotor multi-rotor unmanned aerial vehicle can be 3 shafts 6 rotors, 4 shafts 8 rotors, 6 shafts 12 rotors, 8 shafts 16 rotors, and so on.

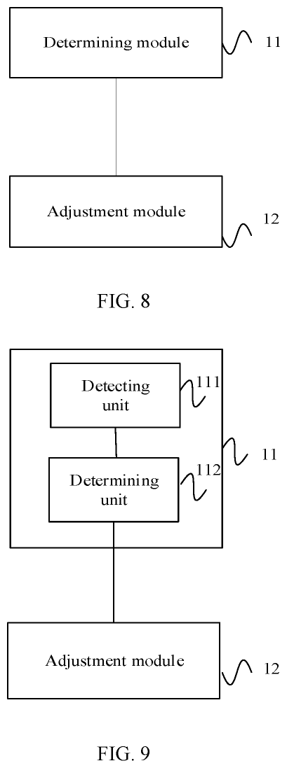

As illustrated in FIG. 8, the flight control device may include a determining module 11, and an adjustment module 12.

The determining module 11 may be configured to determine a current attitude of the multi-rotor unmanned aerial vehicle. The current attitude of the multi-rotor unmanned aerial vehicle may include the normal flight attitude when the carrier 20 is at the lower side of the center frame 10, and the inverted flight attitude when the carrier 20 is at the upper side of the center frame 10. In the normal and inverted flight attitude, an installation position of the carrier 20 on the center frame 10 is same.

The adjustment module 12 may be configured to adjust vertical arrangement positions of the forward-rotating rotors and the counter-rotating rotors in the direction of the yaw axis according to the current attitude of the multi-rotor unmanned aerial vehicle.

The carrier 20 may include at least one of a gimbal device, a spraying device, a cargo-carrying device, or a weapon device. By adopting the flight control method of the multi-rotor unmanned aerial vehicle provided by the present disclosure, it is possible to use a gimbal device to photograph from a top view, or from an upward angle. It is also possible to use a spray device to spray from a top view, or from an upward angle, such as to spray pesticides. The cargo-carrying device may be configured to implement multiple forms of cargo loading. The weapon device may be configured to achieve weapon launch in multiple angels, such as to fire bullets. Of course, the specific type of the carrier 20 in practical applications may not be limited to the types provided above, and may be specifically selected according to actual needs, which is not particularly limited in this embodiment.

As illustrated in FIG. 9, the determining module 11 may include a detecting unit 111 and a determining unit 112.

The detecting unit 111 may be configured to detect a position of the carrier relative to the center frame. The determining unit 112 may be configured to determine that the current attitude of the multi-rotor unmanned aerial is the normal flight attitude when the detecting unit detects that the carrier 20 is at the lower side of the center frame 10, and to determine that the current attitude of the multi-rotor unmanned aerial is the inverted flight attitude when the detecting unit detects that the carrier 20 is at the upper side of the center frame 10.

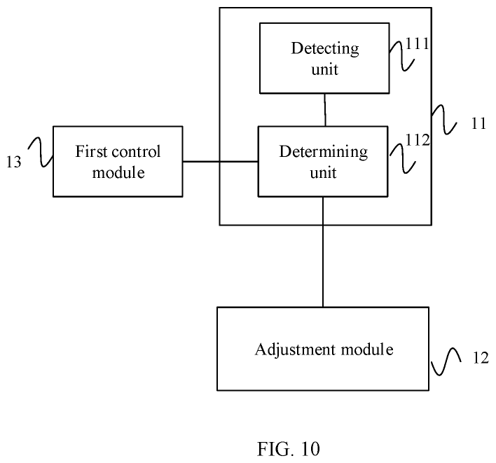

In another embodiment as illustrated in FIG. 10, the flight control device may further include a first control module 13. The first control module 13 may convert the multi-rotor unmanned aerial vehicle from the normal flight attitude control mode to the inverted flight attitude control mode when the center frame is inverted to make the carrier change from a position at the lower side of the center frame to a position at the upper side of the center frame, or convert the multi-rotor unmanned aerial vehicle from the inverted flight attitude control mode to the normal flight attitude control mode when the center frame is inverted to make the carrier change from a position at the upper side of the center frame to a position at the lower side of the center frame.

A change mode of the movement of the multi-rotor unmanned aerial vehicle controlled by the normal flight attitude control mode may be different from a change mode of the movement of the multi-rotor unmanned aerial vehicle controlled by the inverted flight attitude control mode.

In one embodiment, the forward-rotating rotors 41 and the counter-rotating rotors 42 may be detachably connected to the corresponding driving devices.

Correspondingly, the adjustment module 12 may include a first adjustment unit. The first adjustment unit may be configured to adjust the installation positions of the forward-rotating rotor 41 and the counter-rotating rotor 42 on each propulsion assembly 40 to interchange the forward-rotating rotor 41 and the counter-rotating rotor 42 on the propulsion assembly 40, when the multi-rotor unmanned aerial vehicle is switched from the normal flight attitude to the inverted flight attitude, or from the inverted flight attitude to the normal flight attitude.

In another embodiment, for each arm, the propulsion assembly on the arm may be rotatably or detachably connected to the arm.

Correspondingly, the adjustment module 12 may include a second adjustment unit. The second adjustment unit may be configured to control movement of each propulsion assembly 40 relative to a corresponding arm, such that each propulsion assembly 40 maintains a status same as in the normal flight, when the multi-rotor unmanned aerial vehicle is switched from the normal flight attitude to the inverted flight attitude, or from the inverted flight attitude to the normal flight attitude.

In another embodiment, each arm may be rotatably or detachably connected to the center frame 10.

Correspondingly, the adjustment module 12 may include a third adjustment unit. The third adjustment unit may be configured to control each arm to move relative to the center frame, such that each propulsion assembly 40 maintains a status same as in the normal flight, when the center frame is inverted to make the multi-rotor unmanned aerial vehicle being switched from the normal flight attitude to the inverted flight attitude, or from the inverted flight attitude to the normal flight attitude.

In the present disclosure, the vertical arrangement positions of the forward-rotating rotors and the counter-rotating rotors in the propulsion assemblies of the multi-rotor unmanned aerial vehicle may be adjusted according to the current attitude of the multi-rotor unmanned aerial vehicle. Correspondingly, when the multi-rotor unmanned aerial vehicle is in the normal flight attitude when the carrier is located at the lower side of the center frame and in the inverted flight attitude when the carrier is located at the upper side of the center frame, the vertical arrangement positions of the forward-rotating rotor and the counter-rotating rotor in each propulsion assembly in the direction of the yaw axis may remain unchanged, and each rotor may maintain a state of pushing the airflow downward when the rotor rotates. The installation position of the carrier on the center frame may be unchanged. Correspondingly, there may be no need to change the installation position of the carrier on the center frame or dispose extra mounting devices on the upper side of the center frame to mount the carrier. The carrier of the multi-rotor unmanned aerial vehicle may achieve the corresponding function in the top or bottom view angles directly through the normal flight attitude and the inverted flight attitude of the multi-rotor unmanned aerial vehicle. Good control of the multi-rotor unmanned aerial vehicle may be achieved in the normal flight attitude and in the inverted flight attitude, and photographing in multiple angles or other functions may be achieved with the multi-rotor unmanned aerial vehicle.

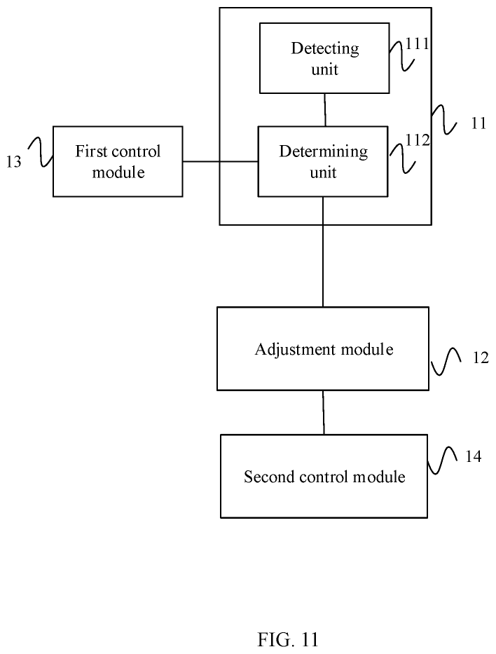

Another embodiment of the present disclosure provides another flight control device for a multi-rotor unmanned aerial vehicle, as illustrated in FIG. 11. Based on the flight control device provided by the embodiment illustrated in FIG. 10, the flight control device may further include a second control module 14.

The second control module 14 may be configured to control movement of the carrier according to the current attitude of the multi-rotor unmanned aerial vehicle.

The second control module 14 may include a first control unit and a second control unit.

The first control unit may make the flight control device control the carrier to move with a first control mode when the multi-rotor unmanned aerial vehicle is in the normal flight attitude.

The second control unit may make the flight control device control the carrier to move with a second control mode when the multi-rotor unmanned aerial vehicle is in the inverted flight attitude.

A change mode of the movement of the carrier controlled by the first control mode may be different from a change mode of the movement of the carrier controlled by the second control mode.

Details of the flight control device are similar to the previous embodiment and can be referred to the description of the previous embodiment.

In the present disclosure, the vertical arrangement positions of the forward-rotating rotors and the counter-rotating rotors in the propulsion assemblies of the multi-rotor unmanned aerial vehicle may be adjusted according to the current attitude of the multi-rotor unmanned aerial vehicle. Correspondingly, when the multi-rotor unmanned aerial vehicle is in the normal flight attitude when the carrier is located at the lower side of the center frame and in the inverted flight attitude when the carrier is located at the upper side of the center frame, the vertical arrangement positions of the forward-rotating rotor and the counter-rotating rotor in each propulsion assembly in the direction of the yaw axis may remains unchanged, and each rotor may maintain a state of pushing the airflow downward when the rotor rotates. The installation position of the carrier on the center frame may be unchanged. Correspondingly, there may be no need to change the installation position of the carrier on the center frame or dispose extra mounting devices on the upper side of the center frame to mount the carrier. The carrier of the multi-rotor unmanned aerial vehicle may achieve the corresponding function in the top or bottom view angles directly through the normal flight attitude and the inverted flight attitude of the multi-rotor unmanned aerial vehicle. Good control of the multi-rotor unmanned aerial vehicle may be achieved in the normal flight attitude and in the inverted flight attitude, and photographing in multiple angles or other functions may be achieved with the multi-rotor unmanned aerial vehicle.

The present disclosure also provides a multi-rotor unmanned aerial vehicle. As illustrated in FIG. 1, the multi-rotor unmanned aerial vehicle may include: a center frame 10, a carrier 20 mounted on the center frame 10, a plurality of arms 30 connected to the center frame 10, and a propulsion assembly 40 on each of the plurality of arms 30 for providing flight propulsion.

The plurality of arms 30 may extend out radially from the center frame 10. The multi-rotor unmanned aerial vehicle may further include a tripod (not shown in the figures) connected to the center frame 10 for supporting the multi-rotor unmanned aerial vehicle when landing.

The multi-rotor unmanned aerial vehicle may wirelessly communicate with a control device and a display device. The multi-rotor unmanned aerial vehicle may perform instructions from the control device, and the display device may display the status of the multi-rotor unmanned aerial vehicle and images photographed by the multi-rotor unmanned aerial vehicle.

Each propulsion assembly 40 may include a forward-rotating rotor 41 and a counter-rotating rotor 42. In each propulsion assembly 40, the forward-rotating rotor 41 and the counter-rotating rotor 42 may be disposed up and down in a direction of a yaw axis. Each propulsion assembly 40 may further include a first driving device 43 for driving the forward-rotating rotor 41 and a second driving device 44 for driving the counter-rotating rotor 42. A center of rotation of the forward-rotating rotor 41 and a center of rotation of the counter-rotating rotor 42 may be coaxial. A direction of rotation of the forward-rotating rotor 41 and a direction of rotation of the counter-rotating rotor 42 may be opposite to each other. The forward-rotating rotor 41 and the counter-rotating rotor 42 may be disposed up and down in a direction of a yaw axis, and may have opposite rotation direction. The forward-rotating rotor 41 and the counter-rotating rotor 42 may rotate with a same speed. Torque applied to the multi-rotor unmanned aerial vehicle by the forward-rotating rotor 41 and the counter-rotating rotor 42 may be canceled by each other, to ensure a balance of the multi-rotor unmanned aerial vehicle. In the case of a same projected area, compared with the arrangement of only one layer, the rotors of the double-layered propulsion assembly can provide propulsion larger than one rotor.

Each rotor may correspond to one driving device. The first driving device 43 and the second driving device 44 in one propulsion assembly may be motors. The motors may be disposed between electronic governors and the rotors. Each motor and one corresponding rotor may be disposed on one corresponding arm. The electronic governors may receive driving signals from the flight controller and provide driving currents to the motors according to the driving signals for controlling the rotation speed of the motors. The motors may drive the rotors to rotate for providing flight propulsion to the multi-rotor unmanned aerial vehicle. The propulsion may enable the multi-rotor unmanned aerial vehicle to move with one or more degrees of freedom. In some embodiments, the multi-rotor unmanned aerial vehicle may rotate about one or more rotation axes. For example, the rotation axis may include a pitch axis (X), a yaw axis (Y), and a roll axis (Z). It should be understood that each motor may be a DC motor or an AC motor. In addition, the motor may be a brushless motor or a brushed motor.

In this embodiment, the plurality of arms 30 may include three or more arms. Each arm 30 may be provided with a propulsion assembly 40. For example, the entire multi-rotor multi-rotor unmanned aerial vehicle can be 3 shafts 6 rotors, 4 shafts 8 rotors, 6 shafts 12 rotors, 8 shafts 16 rotors, and so on.

The flight control device may determine a current attitude of the multi-rotor unmanned aerial vehicle. The current attitude of the multi-rotor unmanned aerial vehicle may be the normal flight attitude when the carrier 20 is at the lower side of the center frame 10, and the inverted flight attitude when the carrier 20 is at the upper side of the center frame 10. In the normal and inverted flight attitude, an installation position of the carrier 20 on the center frame 10 is same.

Determining the current attitude of the multi-rotor unmanned aerial vehicle can detect the position of the carrier 20 relative to the center frame 10. When it is detected that the carrier 20 is located at the lower side of the center frame 10, it is determined that the current attitude of the multi-rotor unmanned aerial vehicle may be the normal flight attitude. When the carrier 20 is detected at the upper side of the center frame 10, it is determined that the current attitude of the multi-rotor unmanned aerial vehicle may be the inverted flight attitude.

In another embodiment, the multi-rotor unmanned aerial vehicle can also receive the normal or inversed flight instruction sent by the control device. When the normal flight instruction is received and the multi-rotor unmanned aerial vehicle responds to the normal flight instruction, the current attitude may be determined to be the normal flight attitude; when the inverted flight instruction is received and the multi-rotor unmanned aerial vehicle responds to the inverted flight instruction, the current attitude is determined to be the inverted flight attitude.

In one embodiment, the flight control device may be configured to control the multi-rotor unmanned aerial vehicle to change from a normal flight attitude control mode to an inverted flight attitude control mode when reversing the center frame 10 to invert the carrier 20 from a position at the lower side of the center frame 10 to a position at the upper side of the center frame 10, or control the multi-rotor unmanned aerial vehicle to change from an inverted flight attitude control mode to a normal flight attitude control mode when reversing the center frame 10 to invert the carrier 20 from a position at the upper side of the center frame 10 to a position at the lower side of the center frame 10.

A change mode of the movement of the multi-rotor unmanned aerial vehicle controlled by the normal flight attitude control mode may be different from a change mode of the movement of the multi-rotor unmanned aerial vehicle controlled by the inverted flight attitude control mode.

The center frame 10 can be inverted by 180 degrees so that the multi-rotor unmanned aerial vehicle can switch between the normal and the inverted flight attitude.

FIG. 3 illustrates an exemplary normal flight attitude of a multi-rotor unmanned aerial vehicle. For description purposes only, the embodiment in FIG. 3 where the multi-rotor unmanned aerial vehicle includes 4 shafts 8 shafts is used as an example to illustrate the present disclosure and should not limit the scopes of the present disclosure. As illustrated in FIG. 3, the multi-rotor unmanned aerial vehicle may include four propulsion assemblies labeled as A, B, C, and D in FIG. 3 respectively. A rotor rotating counter-clockwise to provide downward propulsion may be a forward-rotating rotor, and a rotor rotating clockwise to provide downward propulsion may be a counter-rotating rotor. Directions of rotation referred to in this embodiment are based on that the top view angle as the viewing angle, and FIG. 3 shows the normal flight attitude. Taking the propulsion assembly A as an example, along the direction parallel to the yaw axis Y, an upper rotor may be a forward-rotating rotor 41 and a lower rotor may be a counter-rotating rotor 42. The first driving device 43 of the forward-rotating rotor 41 drives the forward-rotating rotor to rotate counterclockwise. Arc arrows in the figure indicate the rotation direction of the rotors driven by the driving devices. The dotted arrows indicate the direction of the airflow. The rotors may push the airflow downward when they rotate. The air may provide inverted force and the propulsion to the rotors. When the rotating speed of the rotors is larger, the propulsion may be larger. When the overall propulsion of the multi-rotor unmanned aerial vehicle is greater than gravity, the multi-rotor unmanned aerial vehicle may rise; when the overall propulsion of the multi-rotor unmanned aerial vehicle is equal to gravity, the multi-rotor unmanned aerial vehicle may be hovering; when the overall propulsion of the multi-rotor unmanned aerial vehicle is less than gravity, the multi-rotor unmanned aerial vehicle may dropdown. To ensure that the multi-rotor unmanned aerial vehicle can fly normally, it is necessary to ensure that each rotor should push down the airflow when it rotates, so that each rotor can generate upward propulsion.

FIG. 4 illustrates an exemplary multi-rotor unmanned aerial vehicle being inverted only. As illustrated in FIG. 4, the multi-rotor unmanned aerial vehicle based on FIG. 3 may be controlled to be inverted by 180 degrees from front to back, to make the carrier 20 flipped over the center frame 10, and the multi-rotor unmanned aerial vehicle may be in the inverted flight attitude. The multi-rotor unmanned aerial vehicle after being inverted is shown in FIG. 4. Take the propulsion assembly A as an example, after the inversion, the forward-rotating rotor 41 may be located in a lower position parallel to the yaw axis Y. Correspondingly, the rotating direction of the first driving device 43 that drives the forward-rotating rotor to rotate may become clockwise, and becomes inconsistent with the preset rotation direction of the forward-rotating rotor 41. Therefore, if rotating in this state, the airflow generated by the forward-rotating rotor 41 when the forward-rotating rotor 41 rotates may become upwards (as shown by the dotted arrows in FIG. 4). The counter-rotating rotor 42 may be located at an upper position in a direction parallel to the yaw axis Y. The rotation direction of the second driving device 44 that drives the rotation of the counter-rotating rotor 42 may become counterclockwise, and may be inconsistent with the preset rotating direction of the counter-rotating rotor 42. Therefore, if the rotation is performed in this state, the airflow generated by the counter-rotating rotor 42 when the counter-rotating rotor 42 rotates may be upward (as shown by the dotted arrows in FIG. 4). The same is true for the other propulsion assemblies B, C, and D, which will not be repeated here. For details, please be referred to FIG. 4. Correspondingly, each propulsion assembly cannot provide upward propulsion, and the multi-rotor unmanned aerial vehicle cannot fly normally.

In one embodiment, the forward-rotating rotors 41 and the counter-rotating rotors 42 may be detachably connected to the corresponding driving devices. The detachable connection between a forward-rotating rotor 41 and a corresponding driving device, and the connection between a counter-rotating rotor 42 and a respective driving device may include at least one of a threaded connection, a clamp connection, or a pin connection.

Correspondingly, adjusting the vertical arrangement positions of the forward-rotating rotors 41 and the counter-rotating rotors 42 in the direction of the yaw axis according to the current attitude of the multi-rotor unmanned aerial vehicle may include: when the multi-rotor unmanned aerial vehicle is switched from the normal flight attitude to the inverted flight attitude, or from the inverted flight attitude to the normal flight attitude, adjusting the installation positions of the forward-rotating rotor 41 and the counter-rotating rotor 42 on each propulsion assembly 40 to interchange the forward-rotating rotor 41 and the counter-rotating rotor 42 on the propulsion assembly 40.

FIG. 5 illustrates an exemplary status of a multi-rotor unmanned aerial vehicle based on FIG. 4 in an inverted flight using a flight control method consistent with various embodiments of the present disclosure. As illustrated in FIG. 5, the installation positions of the forward-rotating rotor 41 and the counter-rotating rotor 42 in a same propulsion assembly 40 (for example, the propulsion assembly A) may be interchanged. After being interchanged, the forward-rotating rotor 41 may be located at an upper position in the direction parallel to the yaw axis Y, and may be connected to the second driving device 44. The second driving device 44 may correspondingly drive the forward-rotating rotor 41 to rotate. The second driving device 44 may rotate counterclockwise to drive the forward-rotating rotor 41 rotate counterclockwise, and the preset rotation direction of the forward-rotating rotor 41 may be consistent with the rotation direction of the second driving device 44. Therefore, the forward-rotating rotor 41 may push the airflow downward when rotating. The counter-rotating rotor 42 may be located at a lower position in the direction parallel to the yaw axis Y, and may be connected to the first driving device 43 after being interchanged. The first driving device 43 may drive the counter-rotating rotor 42 to rotate. The first driving device 43 may rotate clockwise to drive the counter-rotating rotor 42 rotate clockwise, and the preset rotation direction of the counter-rotating rotor 42 may be consistent with the rotation direction of the first driving device 43. Therefore, the counter-rotating rotor 42 may push the airflow downward when rotating.

The other propulsion assemblies B, C, and D may be operated in a way similar to the propulsion assembly A. For one propulsion assembly, after the installation positions of the forward-rotating rotor 41 and the counter-rotating rotor 42 are interchanged, the vertical arrangement positions of the forward-rotating rotors 41 and the counter-rotating rotors 42 in the direction of the yaw axis may be still maintained. For example, in the propulsion assembly A, the forward-rotating rotor 41 may be always located at the upper position and the counter-rotating rotor 42 may be always located at the lower position, in both the normal and inverted flight attitudes. This may ensure that the multi-rotor unmanned aerial vehicle can fly normally in the normal and inverted flight attitudes.

In another embodiment, for each arm, the propulsion assembly on the arm may be rotatably or detachably connected to the arm. In each arm, the detachable connection between the propulsion assembly and the arm may include at least one of a threaded connection, a clamp connection, or a pin connection, and the rotatable connection between the propulsion assembly and the arm may include at least one of a hinged connection or a pivot connection.

In each arm, a locking device may be disposed between the propulsion assembly 40 and the arm. The locking device may lock the propulsion assembly 40 relative to the arm after the propulsion assembly 40 moves to a preset position relative to the arm.

Correspondingly, adjusting the vertical arrangement positions of the forward-rotating rotors 41 and the counter-rotating rotors 42 in the direction of the yaw axis according to the current attitude of the multi-rotor unmanned aerial vehicle may include: when the multi-rotor unmanned aerial vehicle is switched from the normal flight attitude to the inverted flight attitude, or from the inverted flight attitude to the normal flight attitude, controlling movement of each propulsion assembly 40 relative to a corresponding arm, such that each propulsion assembly 40 maintains a status same as in the normal flight.

The status same as in the normal flight may mean that a corresponding relationship between each driving device and a corresponding rotor is unchanged, the direction of rotation is unchanged, and the up and down position of each rotor is also unchanged. FIG. 6 illustrates another exemplary status of a multi-rotor unmanned aerial vehicle based on FIG. 4 in inverted flight using a flight control method consistent with various embodiments of the present disclosure. When the center frame 10 is inverted by 180 degrees to the state in FIG. 4, each propulsion assembly (for example, the propulsion assembly A) may be reversely turned around a corresponding arm to a status same as the normal flight attitude in FIG. 3. The forward-rotating rotor 41 may be located at an upper position in the direction parallel to the yaw axis Y. The first driving device 43 may drive the forward-rotating rotor 41 to rotate counterclockwise. The preset rotation direction of the forward-rotating rotor 41 may be consistent with the rotation direction of the first driving device 43. When the forward-rotating rotor 41 rotates, it may push the airflow downward. The counter-rotating rotor 42 may be located at a lower position in the direction parallel to the yaw axis Y. The second drive device 44 may drive the counter-rotating rotor 42 to rotate clockwise. The preset rotation direction of the counter-rotating rotor 42 may be consistent with the rotation direction of the second drive device 44. The counter-rotating rotor 42 may push the airflow downward when rotating.

The other propulsion assemblies B, C, and D may be operated in a way similar to the propulsion assembly A. After each propulsion assembly 40 moves to the same status as in the normal flight attitude, for one propulsion assembly, the vertical arrangement positions of the forward-rotating rotors 41 and the counter-rotating rotors 42 in the direction of the yaw axis may be still maintained. For example, in the propulsion assembly A, the forward-rotating rotor 41 may be always driven by the first driving device 43 and the counter-rotating rotor 42 may be always driven by the second driving device 44. The forward-rotating rotor 41 may be always located at the upper position and the counter-rotating rotor 42 may be always located at the lower position, in both the normal and inverted flight attitudes. This may ensure that the multi-rotor unmanned aerial vehicle can fly normally in the normal and inverted flight attitude.

In another embodiment, each arm may be rotatably or detachably connected to the center frame 10.

For each arm, the detachable connection between the arm and the center frame may include at least one of a threaded connection, a clamp connection, or a pin connection, and the rotatable connection between the arm and the center frame 10 may include at least one of a hinged connection or a pivot connection.

For each arm, a locking device may be disposed between the arm and the center frame 10. The locking device may lock the arm relative to the center frame after the arm moves to a preset position relative to the center frame.

Correspondingly, adjusting the vertical arrangement positions of the forward-rotating rotors 41 and the counter-rotating rotors 42 in the direction of the yaw axis according to the current attitude of the multi-rotor unmanned aerial vehicle may include: when the center frame is inverted to convert the multi-rotor unmanned aerial vehicle from the normal flight attitude to the inverted flight attitude, or from the inverted flight attitude to the normal flight attitude, controlling each arm to move relative to the center frame, such that each propulsion assembly 40 maintain a status same as in the normal flight. The method may be achieved in a way similar to the previous embodiment.

When the multi-rotor unmanned aerial vehicle is switched from the inverted flight attitude to the normal flight attitude, the vertical arrangement positions of the forward-rotating rotors 41 and the counter-rotating rotors 42 in the direction of the yaw axis may be adjusted similarly, to ensure that each rotor provides propulsion.

The carrier 20 may include at least one of a gimbal device, a spraying device, a cargo-carrying device, or a weapon device. By adopting the flight control method of the multi-rotor unmanned aerial vehicle provided by the present disclosure, it is possible to use a gimbal device to photograph from a top view, or from an upward angle. It is also possible to use a spray device to spray from a top view, or from an upward angle, such as to spray pesticides. The cargo-carrying device may be configured to implement multiple forms of cargo loading. The weapon device may be configured to achieve weapon launch in multiple angels, such as to fire bullets. Of course, the specific type of the carrier 20 in practical applications may not be limited to the types provided above, and may be specifically selected according to actual needs, which is not particularly limited in this embodiment.

In the present disclosure, the vertical arrangement positions of the forward-rotating rotors and the counter-rotating rotors in the propulsion assemblies of the multi-rotor unmanned aerial vehicle may be adjusted according to the current attitude of the multi-rotor unmanned aerial vehicle. Correspondingly, when the multi-rotor unmanned aerial vehicle is in the normal flight attitude when the carrier is located at the lower side of the center frame and in the inverted flight attitude when the carrier is located at the upper side of the center frame, the vertical arrangement positions of the forward-rotating rotor and the counter-rotating rotor in each propulsion assembly in the direction of the yaw axis may remain unchanged, and each rotor may maintain a state of pushing the airflow downward when the rotor rotates. The installation position of the carrier on the center frame may be unchanged. Correspondingly, there may be no need to change the installation position of the carrier on the center frame or dispose extra mounting devices on the upper side of the center frame to mount the carrier. The carrier of the multi-rotor unmanned aerial vehicle may achieve the corresponding function in the top or bottom view angles directly through the normal flight attitude and the inverted flight attitude of the multi-rotor unmanned aerial vehicle.

In another embodiment based on the previous embodiment, the flight control device may be configured to control the movement of the carrier on the multi-rotor unmanned aerial vehicle according to the current attitude of the multi-rotor unmanned aerial vehicle.

When the multi-rotor unmanned aerial vehicle is in the normal flight attitude, the carrier of the multi-rotor unmanned aerial vehicle may be controlled to move in a first control mode. When the multi-rotor unmanned aerial vehicle is in the inverted flight attitude, the carrier of the multi-rotor unmanned aerial vehicle may be controlled to move in a second control mode.

A change of the movement of the carrier controlled by the first control mode may be different from a change of the movement of the carrier controlled by the second control mode.

After the multi-rotor unmanned aerial vehicle is inverted, its control orientation may change. For example, for each rotation shaft and a same control instruction, the control device may control a corresponding rotary shaft mechanism to rotate clockwise around a corresponding rotating axis when the multi-rotor unmanned aerial vehicle is in the normal flight attitude, and may control the corresponding rotary shaft mechanism to rotate counterclockwise around the corresponding rotating axis when the multi-rotor unmanned aerial vehicle is in the inverted flight attitude.

When the carrier is a gimbal device for photographing an object on the ground, if the multi-rotor unmanned aerial vehicle is in the normal flight attitude, a user may input a control instruction through a manipulation device, and the control instruction may make the gimbal device rotate counterclockwise around the pitch axis X. For example, the user may rotate a pull-wheel on the manipulation device clockwise, and the control device may control the gimbal device to rotate counterclockwise around the pitch axis X using a first control mode. Correspondingly, the photographing device may move away from the center frame 10 to point at the photographing object on the ground. If the multi-rotor unmanned aerial vehicle is in the inverted flight attitude, the user may still input the control instruction that will make the gimbal device rotate counterclockwise around the pitch axis X according to habit, for example, by rotating the pull-wheel on the manipulation device counterclockwise. The control device may control the gimbal device to rotate clockwise around the pitch axis X using a second control mode. Correspondingly, the photographing device may move close to the center frame 10 to point at the photographing object on the ground.

When the gimbal device photographs in the bottom view angle, the gimbal device may need to move away from the center frame 10 in the inverted flight attitude. The user may generate the control instruction making the gimbal device rotate clockwise around the pitch axis X. The control device may control the gimbal device to rotate counterclockwise around the pitch axis X using the second control mode. Correspondingly, the photographing device may move away from the center frame 10 to point at the photographing object in the bottom view angle.

In the present disclosure, the vertical arrangement positions of the forward-rotating rotors and the counter-rotating rotors in the propulsion assemblies of the multi-rotor unmanned aerial vehicle may be adjusted according to the current attitude of the multi-rotor unmanned aerial vehicle. Correspondingly, when the multi-rotor unmanned aerial vehicle is in the normal flight attitude when the carrier is located at the lower side of the center frame and in the inverted flight attitude when the carrier is located at the upper side of the center frame, the vertical arrangement positions of the forward-rotating rotor and the counter-rotating rotor in each propulsion assembly in the direction of the yaw axis may remain unchanged, and each rotor may maintain a state of pushing the airflow downward when the rotor rotates. The installation position of the carrier on the center frame may be unchanged. Correspondingly, there may be no need to change the installation position of the carrier on the center frame or dispose extra mounting devices on the upper side of the center frame to mount the carrier. The carrier of the multi-rotor unmanned aerial vehicle may achieve the corresponding function in the top or bottom view angles directly through the normal flight attitude and the inverted flight attitude of the multi-rotor unmanned aerial vehicle. Good control of the multi-rotor unmanned aerial vehicle may be achieved in the normal flight attitude and in the inverted flight attitude, and photographing in multiple angles or other functions may be achieved with the multi-rotor unmanned aerial vehicle.

Those of ordinary skill in the art will appreciate that the example elements and algorithm steps described above can be implemented in electronic hardware, or in a combination of computer software and electronic hardware. Whether these functions are implemented in hardware or software depends on the specific application and design constraints of the technical solution. One of ordinary skill in the art can use different methods to implement the described functions for different application scenarios, but such implementations should not be considered as beyond the scope of the present disclosure.

For simplification purposes, detailed descriptions of the operations of example systems, devices, and units may be omitted, and references can be made to the descriptions of the example methods.

The disclosed systems, apparatuses, and methods may be implemented in other manners not described here. For example, the devices described above are merely illustrative. For example, the division of units may only be a logical function division, and there may be other ways of dividing the units. For example, multiple units or components may be combined or may be integrated into another system, or some features may be ignored, or not executed. Further, the coupling or direct coupling or communication connection shown or discussed may include a direct connection or an indirect connection or communication connection through one or more interfaces, devices, or units, which may be electrical, mechanical, or in other forms.

The units described as separate components may or may not be physically separate, and a component shown as a unit may or may not be a physical unit. That is, the units may be located in one place or may be distributed over a plurality of network elements. Some or all of the components may be selected according to the actual needs to achieve the object of the present disclosure.

In addition, the functional units in the various embodiments of the present disclosure may be integrated in one processing unit, or each unit may be an individual physically unit, or two or more units may be integrated in one unit.

A method consistent with the disclosure can be implemented in the form of computer program stored in a non-transitory computer-readable storage medium, which can be sold or used as a standalone product. The computer program can include instructions that enable a computer device, such as a personal computer, a server, or a network device, to perform part or all of a method consistent with the disclosure, such as one of the example methods described above. The storage medium can be any medium that can store program codes, for example, a USB disk, a mobile hard disk, a read-only memory (ROM), a random access memory (RAM), a magnetic disk, or an optical disk.

Other embodiments of the disclosure will be apparent to those skilled in the art from consideration of the specification and practice of the embodiments disclosed herein. It is intended that the specification and examples be considered as example only and not to limit the scope of the disclosure, with a true scope and spirit of the invention being indicated by the following claims.

What is claimed is:

1. A flight control method for a multi-rotor unmanned aerial vehicle, wherein the multi-rotor unmanned aerial vehicle includes a center frame, a carrier mounted on the center frame, a plurality of arms connected to the center frame, and a propulsion assembly on each of the plurality of arms for providing flight propulsion, wherein:
each propulsion assembly includes a forward-rotating rotor, a counter-rotating rotor, a first driving device for driving the forward-rotating rotor to rotate, and a second driving device for driving the counter-rotating rotor to rotate, wherein the forward-rotating rotor and the counter-rotating rotor are arranged vertically in a direction of a yaw axis; and the forward-rotating rotor and the counter-rotating rotor have rotating centers in a same axis and have opposite rotating directions,
the method comprising:
determining a current attitude of the multi-rotor unmanned aerial vehicle, wherein the current attitude of the multi-rotor unmanned aerial vehicle includes a normal flight attitude when the carrier is at a lower side of the center frame, and an inverted flight attitude when the carrier is at an upper side of the center frame, and in the normal and inverted flight attitudes, an installation position of the carrier on the center frame remains unchanged; and
adjusting vertical arrangement positions of the forward-rotating rotor and the counter-rotating rotor in each propulsion assembly in the direction of the yaw axis according to the current attitude of the multi-rotor unmanned aerial vehicle, such that the vertical arrangement positions of the forward-rotating rotor and the counter-rotating rotor in each propulsion assembly in the direction of the yaw axis remain unchanged under the normal and inverted flight attitudes, and when rotating, each rotor maintains a state of pushing down airflow.

2. The method according to claim 1, wherein the carrier includes at least one of a gimbal device, a spray device, a cargo device, or a weapon device.

3. The method according to claim 1, wherein determining the current attitude of the multi-rotor unmanned aerial vehicle includes:
detecting a position of the carrier relative to the center frame;
when it is detected that the carrier is located at the lower side of the center frame, determining the current attitude of the multi-rotor unmanned aerial vehicle is the normal flight attitude; and
when it is detected that the carrier is located at the upper side of the center frame, determining the current attitude of the multi-rotor unmanned aerial vehicle is the inverted flight attitude.

4. The method according to claim 1, further including:
controlling the multi-rotor unmanned aerial vehicle to change from a normal flight attitude control mode to an inverted flight attitude control mode, when inverting the center frame to invert the carrier from the position at the lower side of the center frame to the position at the upper side of the center frame; or
controlling the multi-rotor unmanned aerial vehicle to change from the inverted flight attitude control mode to the normal flight attitude control mode, when inverting the center frame to invert the carrier from the position at the upper side of the center frame to the position at the lower side of the center frame.

5. The method according to claim 4, wherein:
in each propulsion assembly, the forward-rotating rotor and the counter-rotating rotor are detachably connected to a corresponding driving device respectively; and
adjusting the vertical arrangement positions of the forward-rotating rotor and the counter-rotating rotor of each propulsion assembly in the direction of the yaw axis according to the current attitude of the multi-rotor unmanned aerial vehicle includes:
when the multi-rotor unmanned aerial vehicle is switched from the normal flight attitude to the inverted flight attitude or from the inverted flight attitude to the normal flight attitude, adjusting installation positions of the forward-rotating rotor and the counter-rotating rotor of each propulsion assembly to interchange the forward-rotating rotor and the counter-rotating rotor on the propulsion assembly.

6. The method according to claim 4, wherein:
for each arm of the plurality of arms, the propulsion assembly on the arm is rotatably or detachably connected to the arm; and
adjusting the vertical arrangement positions of the forward-rotating rotor and the counter-rotating rotor of each propulsion assembly in the direction of the yaw axis according to the current attitude of the multi-rotor unmanned aerial vehicle includes:
after inverting the center frame to switch the multi-rotor unmanned aerial vehicle from the normal flight attitude to the inverted flight attitude or from the inverted flight attitude to the normal flight attitude, controlling a movement of each propulsion assembly relative to a corresponding arm, such that each propulsion assembly maintains a status same as in a normal flight.

7. The method according to claim 4, wherein:
each of the plurality of arms is rotatably or detachably connected to the center frame; and
adjusting the vertical arrangement positions of the forward-rotating rotor and the counter-rotating rotor of each propulsion assembly in the direction of the yaw axis according to the current attitude of the multi-rotor unmanned aerial vehicle includes:
after inverting the center frame to switch the multi-rotor unmanned aerial vehicle from the normal flight attitude to the inverted flight attitude, or from the inverted flight attitude to the normal flight attitude, controlling a movement of each of the plurality of arms relative to the center frame, to make each propulsion assembly maintain a status same as in a normal flight.

8. The method according to claim 1, further including controlling a movement of the carrier according to the current attitude of the multi-rotor unmanned aerial vehicle.

9. The method according to claim 8, wherein controlling the movement of the carrier according to the current attitude of the multi-rotor unmanned aerial vehicle includes:
when a flight attitude of the multi-rotor unmanned aerial vehicle is determined to be the normal flight attitude, controlling the carrier of the multi-rotor unmanned aerial vehicle to move in a first control mode; and
when a flight attitude of the multi-rotor unmanned aerial vehicle is determined to be the inverted flight attitude, controlling the carrier of the multi-rotor unmanned aerial vehicle to move in a second control mode,
wherein:
a change mode of the movement of the carrier controlled by the first control mode is different from a change mode of the movement of the carrier controlled by the second control mode.

10. The method according to claim 9, wherein the plurality of arms includes at least three arms, and each arm is configured with a propulsion assembly.

11. A multi-rotor unmanned aerial vehicle, comprising:
a center frame;
a carrier mounted on the center frame;
a plurality of arms connected to the center frame;
a propulsion assembly on each of the plurality of arms for providing flight propulsion; and
a flight control device,
wherein:
each propulsion assembly includes a forward-rotating rotor and a counter-rotating rotor arranged vertically in a direction of a yaw axis, a first driving device for driving the forward-rotating rotor to rotate, and a second driving device for driving the counter-rotating rotor to rotate;
the forward-rotating rotor and the counter-rotating rotor have rotating centers in a same axis and have opposite rotating directions;
the flight control device is configured to determine a current attitude of the multi-rotor unmanned aerial vehicle, and adjust vertical arrangement positions of the forward-rotating rotor and the counter-rotating rotor of each propulsion assembly in the direction of the yaw axis according to the current attitude of the multi-rotor unmanned aerial vehicle;
the current attitude of the multi-rotor unmanned aerial vehicle includes a normal flight attitude when the carrier is at the lower side of the center frame, and an inverted flight attitude when the carrier is at the upper side of the center frame;
in the normal and inverted flight attitudes, an installation position of the carrier on the center frame remains unchanged; and
the flight control device is configured to adjust the vertical arrangement positions of the forward-rotating rotor and the counter-rotating rotor in each propulsion assembly in the direction of the yaw axis according to the current attitude of the multi-rotor unmanned aerial vehicle, such that the vertical arrangement positions of the forward-rotating rotor and the counter-rotating rotor in each propulsion assembly in the direction of the yaw axis remain unchanged under the normal and inverted flight attitudes, and each rotor maintains a state of pushing down airflow when rotating.

12. The multi-rotor unmanned aerial vehicle according to claim 11, wherein:
the carrier includes at least one of a gimbal device, a spray device, a cargo device, or a weapon device.

13. The multi-rotor unmanned aerial vehicle according to claim 11, wherein:
the flight control device is further configured to detecting a position of the carrier relative to the center frame;
when the carrier is detected to be located at the lower side of the center frame, the flight control device determines the current attitude of the multi-rotor unmanned aerial vehicle is the normal flight attitude; and
when the carrier is detected to be located at the upper side of the center frame, the flight control device determines the current attitude of the multi-rotor unmanned aerial vehicle is the inverted flight attitude.

14. The multi-rotor unmanned aerial vehicle according to claim 11, wherein the flight control device is further configured to:
control the multi-rotor unmanned aerial vehicle to change from the normal flight attitude control mode to the inverted flight attitude control mode when inverting the center frame to invert the carrier from the position at the lower side of the center frame to the position at the upper side of the center frame; or control the multi-rotor unmanned aerial vehicle to change from the inverted flight attitude control mode to the normal flight attitude control mode when inverting the center frame to invert the carrier from the position at the upper side of the center frame to the position at the lower side of the center frame.

15. The multi-rotor unmanned aerial vehicle according to claim 14, wherein:
in each propulsion assembly, the forward-rotating rotor and the counter-rotating rotor are detachably connected to a corresponding driving device respectively; and
when the multi-rotor unmanned aerial vehicle is switched from the normal flight attitude to the inverted flight attitude, or from the inverted flight attitude to the normal flight attitude, the flight control device adjusts installation positions of the forward-rotating rotor and the counter-rotating rotor of each propulsion assembly to interchange the forward-rotating rotor and the counter-rotating rotor on the propulsion assembly.

16. The multi-rotor unmanned aerial vehicle according to claim 15, wherein:
in each propulsion assembly, a detachable connection mode connecting the forward-rotating rotor or the counter-rotating rotor to a corresponding driving device includes at least one of a threaded connection, a clamp connection, or a pin connection.

17. The multi-rotor unmanned aerial vehicle according to claim 14, wherein:
the propulsion assembly on each arm of the plurality of arms is rotatably or detachably connected to the corresponding arm; and
when the center frame is inverted to switch the multi-rotor unmanned aerial vehicle from the normal flight attitude to the inverted flight attitude or from the inverted flight attitude to the normal flight attitude, the flight control device is configured to control a movement of each propulsion assembly relative to a corresponding arm, such that each propulsion assembly maintains a status same as in a normal flight.

18. The multi-rotor unmanned aerial vehicle according to claim 17, wherein:
a detachable connection mode of the propulsion assembly on each arm of the plurality of arms and a corresponding arm includes at least one of a threaded connection, a clamp connection, or a pin connection; or
a rotatable connection mode of the propulsion assembly on each arm of the plurality of arms and a corresponding arm includes at least one of a hinge connection or a pivot connection.

19. The multi-rotor unmanned aerial vehicle according to claim 18, wherein:
a locking device is located between each arm of the plurality of arms and the center frame, and is configured to lock the arm relative to the center frame after the arm moves to a preset position relative to the center frame.

20. The multi-rotor unmanned aerial vehicle according to claim 14, wherein:
each of the plurality of arms is rotatably or detachably connected to the center frame; and
when inverting the center frame to switch the multi-rotor unmanned aerial vehicle from the normal flight attitude to the inverted flight attitude or from the inverted flight attitude to the normal flight attitude, controlling a movement of each of the plurality of arms relative to the center frame, such that each propulsion assembly maintains a status same as in a normal flight.
